(19) United States
(12) Patent Application Publication
(10) Pub. No.: US 2023/0399267 A1
(43) Pub. Date: Dec. 14, 2023

(54) COPPER-CERAMIC SUBSTRATE

(71) Applicant: AURUBIS STOLBERG GMBH & CO. KG, Stolberg (DE)

(72) Inventors: Benjamin CAPPI, Neu-Moresnet (BE); Helge LEHMANN, Hürtgenwald (DE)

(21) Appl. No.: 18/033,573

(22) PCT Filed: Oct. 29, 2021
(86) PCT No.: PCT/EP2021/080163

§ 371 Date: Apr. 25, 2023

(30) Foreign Application Priority Data
Nov. 2, 2020 (DE) 10 2020 213 729.3

(51) Int. Cl. C04B 37/02; B32B 15/20; B32B 9/00; B32B 9/04

(52) U.S. Cl. CPC C04B 37/02; B32B 15/20; B32B 9/005; B32B 9/041; C04B 2237/407; B32B 2307/536

(57) ABSTRACT

The invention relates to a copper-ceramic substrate comprising a ceramic support and at least one copper layer bonded to a surface of the ceramic support, the copper layer having a Cu content of at least 99.5% Cu, the copper layer having an Ag content of at least 50 ppm, and the copper layer having an Ag content of not more than 3000 ppm.

The invention relates to a copper-ceramic substrate having the features of the preamble of claim 1.

Copper-ceramic substrates (e.g., DCB, AMB) are used, for example, to manufacture electronic power modules and are a composite of a ceramic carrier having copper layers either on one side or on both sides. The copper layers are usually prefabricated as semi-finished copper products in the form of a copper foil with a thickness of 0.1 to 1.0 mm and are bonded to the ceramic carrier using a bonding method. Such connection methods are also known as DCB (direct copper bonding) or as AMB (active metal brazing). In the case of a higher strength of the ceramic carrier, however, copper plies or copper layers with an even greater thickness can also be applied, which is fundamentally advantageous with regard to the electrical and thermal properties.

Ceramic plates made of, for example, mullite, Al₂O₃, Si₃N₄, AlN, ZTA, ATZ, TiO₂, ZrO₂, MgO, CaO, CaCO₃, or a mixture of at least two of these materials are used as the ceramic carrier.

It is known that copper-ceramic substrates having a copper layer with a fine structure, for example with a mean grain size of no more than 100 μm, at least on the open surface facing away from the ceramic carrier, have fundamental advantages with regard to suitability for visual inspection, for bonding capability with fine wire bonding for wire diameters less than 50 μm, etching behavior for very fine structures, grain boundary configuration, galvanizability and further processing in general. Accordingly, a fine and homogeneous structure is advantageous in the copper layer, primarily on the open surface. Moreover, a fine, and thus harder, structure offers higher mechanical resistance to mechanical damage (e.g., scratches).

The process control during the DCB method occurs just below the melting point of copper instead of at temperatures >1050° C. The soldering processes during the AMB method occur at temperatures ≥800° C. The thermal effect in the AMB and DCB manufacturing processes coarsens the copper, this tendency being enhanced as purity increases. Therefore, a higher resistance of the copper or copper alloy to coarse grain formation is required.

A higher concentration of alloy elements in the copper, i.e., copper with reduced purity, is diametrically opposed to the conductivity requirements of the copper layer, which, corresponding to the requirements in the end use of the copper-ceramic substrate, are in the range of at least 55 MS/m. Furthermore, the copper-ceramic substrate is supposed to be economic to manufacture.

Against this background, the object of the invention is to provide a copper-ceramic substrate which has a fine and homogeneous microstructure and a high conductivity and is inexpensive to produce.

According to the invention, a copper-ceramic substrate having the features of claim 1 is proposed to achieve the object. Further preferred developments can be found in the dependent claims.

Therefore, a copper-ceramic substrate comprising a ceramic carrier and at least one copper layer bonded to the surface of the ceramic carrier is proposed. The copper layer has a Cu (copper) content of at least 99.5%. The copper layer further has an Ag (silver) content of at least 50 ppm and an Ag content of not more than 3000 ppm. The copper layer can obtain further portions of other elements.

In advantageous embodiments, the copper-ceramic substrate comprises two copper layers which are each bonded to a surface of the ceramic carrier.

Furthermore, an advantageous embodiment is proposed, wherein the copper layer has a Cu (copper) content of at least 99.7%, for example 99.8%.

In the copper layer or in the copper layers of the copper-ceramic substrate, fine grain formation can be achieved by the proposed portions. A fine and homogeneous structure is formed in the copper layer. Mean grain sizes of not more than 100 μm may be achieved and can also be maintained at the high required process temperatures.

According to one advantageous embodiment, it is proposed that the copper layer has a mean grain size between 40 μm and 100 μm, more preferably between 40 μm and 80 μm. The mean grain size can further preferably be between 40 μm and 60 μm, further for example 50 μm. The standard deviation of the mean grain size can be, for example, less than 30 μm. Accordingly, the copper layers, in particular the open surface area of the copper substrate or of the copper layers, meet the high requirements of a fine and homogeneous microstructure for various applications. The copper layer is thus particularly well suited for visual inspection and for the bonding capability during the fine wire bonding. Furthermore, due to the fine and homogeneous microstructure, the copper layer exhibits particularly good etching behavior for very fine structures and a particular suitability for galvanic coating methods, in particular because of particularly flat grain boundary trenches and the associated low roughness. Homogeneous and constant mechanical properties of the surface and of the structure help achieve uniform properties in further processing operations. A corresponding further processing operation can be, for example, wire bonding by means of ultrasound methods, wherein bonding wires having diameters, for example, in the range from 10 to 100 μm, have to be joined with pinpoint accuracy. In this case, the structural homogeneity in the contacting points of the bonding wires is of great importance. As a result of the fine grain formation, an increased strength of the copper layer can also be achieved in accordance with the Hall-Petch relationship.

The surface of the copper layer is particularly suitable for soldering of chips, in particular in the case of progressive miniaturization of the chips, because the homogeneous and fine structure can reduce stress gradients in the region of soldered chips, which increases the quality of the soldering and the service life of the solder joint compared to a coarse and inhomogeneous structure.

The proposed copper-ceramic substrate simultaneously provides high conductivity >55 MS/m in the copper layer/layers due to the high copper content.

A particular cost advantage results from the fact that the copper-ceramic substrate can be produced both by active metal brazing (AMB) and by direct copper bonding (DCB). In particular, the copper-ceramic substrate can also be produced by means of AMB with silver-free solders, which require higher solder temperatures ≥1000° C. The copper-ceramic substrate may also be produced via further thermal joining methods, for example thermal diffusion bonding. The proposed copper-ceramic substrate accordingly has a high resistance to coarse grain formation.

It is proposed that the copper layer has a penetration hardness of at least 0.7 GPa for penetration depths between 0.4 μm and 0.6 μm.

It is further proposed that the copper layer has a penetration hardness of at least 0.8 GPa for penetration depths between 0.1 μm and 0.25 μm.

The high surface hardness of the copper layer, primarily for low penetration depths <1 μm, which can be determined in particular by means of a depth-resolved QCSM method, results in a higher resistance to mechanical effects (for example a higher resistance to scratches) during further processing or also during transport to these processes. A higher surface quality can thus be ensured. Likewise, a correspondingly high surface hardness in the indicated region is advantageous for a plurality of further processing methods.

According to a further development, it is proposed that the copper layer has an Ag content of not more than 800 ppm. This can lead in particular to a cost reduction.

It is further proposed that the copper layer has a P (phosphorus) content of not more than 30 ppm. It was recognized that the presence of phosphorus can suppress the positive, grain-refining behavior of the proposed alloy. This applies in particular to commercially traded copper, which can regularly contain more phosphorus. It has been found that the negative influence can be effectively reduced by the proposed limitation of the P content.

It is further proposed that the copper layer has a P content of at least 0.1 ppm. A further reduction of the phosphorus content does not achieve further improvement of the properties of the copper layer.

According to a further preferred embodiment, the copper layer has an O (oxygen) content of not more than 10 ppm, more preferably not more than 5 ppm. A correspondingly low oxygen content achieves sufficient hydrogen resistance, so that various method steps can take place in a hydrogen atmosphere. At the same time, a low oxygen content, in particular a maximum O of 5 ppm, has a positive effect on the conductivity of the copper layer.

It is further proposed that the copper layer has an O content of at least 0.1 ppm. A further reduction in the oxygen content does not achieve any further improvement in the properties of the copper layer.

It is further proposed that
the copper layer has a content of the elements Cd, Ce, Ge, V, Zn in each case from a minimum of 0.01 ppm to a maximum of 1 ppm, wherein
the copper layer according to a further preferred embodiment has a content of the elements Cd, Ce, Ge, V, Zn of, altogether, at least 0.1 ppm and not more than 5 ppm. As a result, the achievement of a high conductivity and a corresponding fine microstructure can be simplified.

It is further proposed that
the copper layer has a content of the elements Bi, Se, Sn, Te in each case from a minimum of 0.01 to a maximum of 2 ppm, wherein
the copper layer according to a further preferred embodiment has a content of the elements Bi, Se, Sn, Te of, altogether, least 0.1 ppm and not more than 8 ppm. As a result, the achievement of a high conductivity and a corresponding fine microstructure can be simplified.

It is further proposed that
the copper layer has a content of the elements Al, Sb, Ti, Zr in each case from a minimum of 0.01 ppm to a maximum of 3 ppm, wherein
the copper layer according to a further preferred embodiment has a content of the elements Al, Sb, Ti, Zr of, altogether, at least 0.1 ppm and not more than 10 ppm. As a result, the achievement of a high conductivity and a corresponding fine microstructure can be simplified.

It is further proposed that
the copper layer has a content of the elements As, Co, In, Mn, Pb, Si in each case from a minimum of 0.01 to a maximum of 5 ppm, wherein
the copper layer according to a further preferred embodiment has a content of the elements As, Co, In, Mn, Pb, Si of, altogether, at least 0.1 ppm and not more than 20 ppm. As a result, the achievement of a high conductivity and a corresponding fine microstructure can be simplified.

It is further proposed that
the copper layer has a content of the elements B, Be, Cr, Fe, Mn, Ni, S in each case from a minimum of 0.01 to a maximum of 10 ppm, wherein
the copper layer according to a further preferred embodiment has a content of the elements B, Be, Cr, Fe, Mn, Ni, S of, altogether, at least 0.1 ppm and not more than 50 ppm. As a result, the achievement of a high conductivity and a corresponding fine microstructure can be simplified.

It is further proposed that the copper layer has a content of the elements Cd, Ce, Ge, V, Zn, Bi, Se, Sn, Te, Al, Sb, Ti, Zr, As, Co, In, Mn, Pb, Si, B, Be, Cr, Fe, Mn, Ni, S including further impurities of not more than 50 ppm. As a result, the achievement of a high conductivity and a corresponding fine microstructure can be simplified.

The aforementioned contents refer in each case to the weight fractions.

The invention is explained below using preferred embodiments with reference to accompanying figures. Shown are:

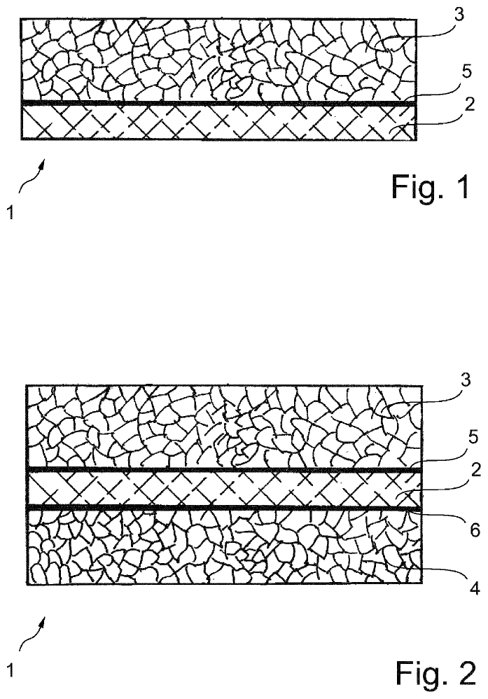

FIG. 1 a copper-ceramic substrate having one copper layer;

FIG. 2 a copper-ceramic substrate having two copper layers;

FIG. 3 a micrograph of a fine copper layer according to the invention of a copper-ceramic substrate according to the DCB process;

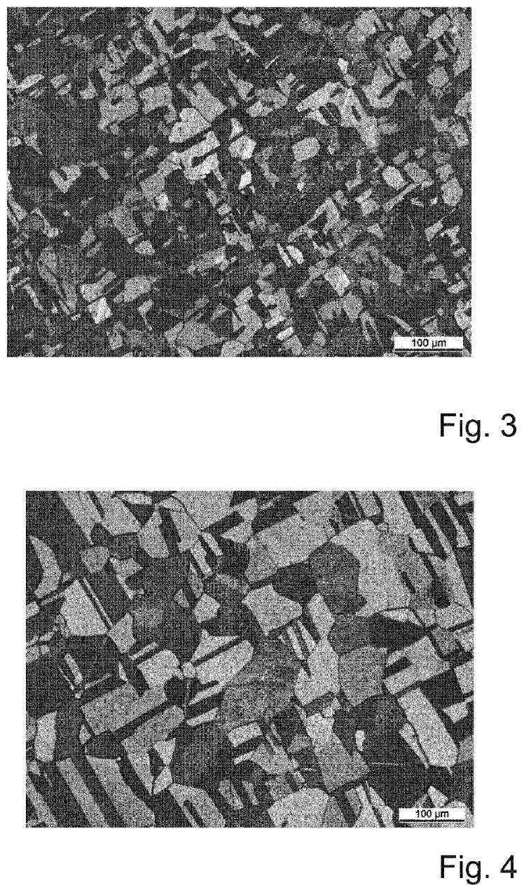

FIG. 4 a micrograph of a fine copper layer of a copper-ceramic substrate according to the invention according to the AMB process;

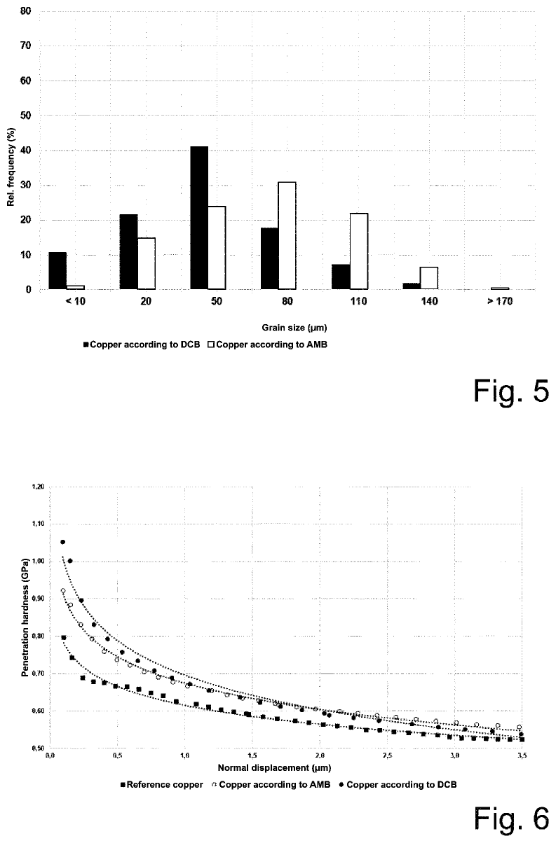

FIG. 5 grain size distribution of copper layers according to the invention of a copper-ceramic substrate according to the DCB process and AMB process;

FIG. 6 nanohardness of copper layers according to the invention of a copper-ceramic substrate according to the DCB process and AMB process compared to a reference copper; and

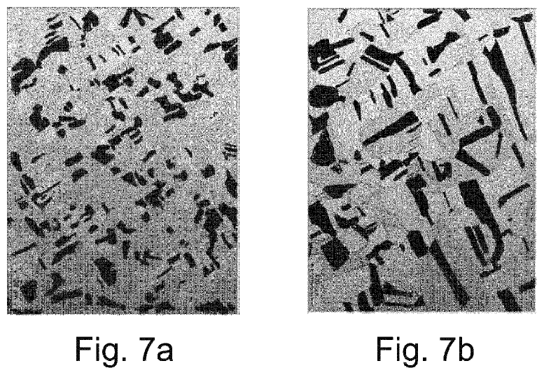

FIG. 7 shows micrographs with identification of the area portion of crystal twins of copper layers according to the invention of a copper-ceramic substrate according to the DCB process and AMB process in comparison.

Power modules are semiconductor components of power electronics and are used as semiconductor switches. They contain a plurality of power semiconductors (chips) that are electrically insulated from the heat sink in one housing. These are applied to a metallized surface of an electrically insulating plate (for example, made of ceramic material) by means of soldering or bonding, so that on the one hand the heat emission toward the base plate is ensured and on the other hand the electrical insulation is ensured. The composite of metallized layers and insulating plate is called a copper-ceramic substrate 1 and is made on an industrial scale using the so-called DCB technology (direct copper bonding) or using the so-called AMB technology (active metal brazing).

The chips are contacted by bonding with thin bonding wires. In addition, further modules with different functions (e.g., sensors, resistors) can be present and integrated.

To produce a DCB substrate, ceramic carriers 2 (e.g., Al₂O₃, Si₃N₄, AlN, ZTA, ATZ) are joined to one another at the top and bottom using copper layers 3, 4 in a bonding process. In preparation for this process, the copper layers 3, 4 can, before being placed onto the ceramic carrier 2, be surface-oxidized, (e.g., chemically or thermally) and then placed onto the ceramic carrier 2. The joint (bonding) is produced in a high-temperature process ≥1050° C., wherein a eutectic melt is produced on the surface of the copper layer 3, 4, said eutectic melt forming a bond with the ceramic carrier 2. In the case of copper (Cu) on aluminum oxide (Al₂O₃), for example, this connection consists of a thin Cu—Al spinel layer.

To produce an AMB substrate, the copper layers 3, 4 are soldered onto a ceramic carrier 2 by means of a suitable brazing solder. The soldering process takes place in a vacuum or in a suitable protective atmosphere, for example hydrogen, at temperatures >800° C. These can be batch processes or continuous processes. The use of silver-free solders (e.g. CuAlTiSi solders) increases the required process temperature, so that these soldering processes can take place at temperatures up to 1050° C.

Furthermore, methods can also be used for producing the copper-ceramic substrate 1 in which the bonding between copper and ceramic is produced via a diffusion-based joining process (e.g., thermal diffusion bonding). The process temperatures here likewise are ≥1000° C.

FIG. 1 shows a schematic illustration of an exemplary embodiment of a copper-ceramic substrate 1 with a ceramic carrier 2 and a proposed copper layer 3. The copper layer 3 has a high copper content Cu of at least 99.5%, a silver content of at least 50 ppm Ag and not more than 3000 ppm Ag being provided.

The copper layer 3 can be joined to the ceramic carrier 2, for example, according to the DCB method described at the outset or with the AMB method, so that the copper layer is joined to the ceramic carrier 2 by an integral joint in the surface edge zone 5.

FIG. 2 shows a schematic illustration of an exemplary embodiment of a copper-ceramic substrate 1 with a ceramic carrier 2 analogous to the exemplary embodiment of FIG. 1, wherein, by contrast, two proposed copper layers 3 and 4 are provided. The copper layers 3 and 4 have a high copper content of at least 99.5% Cu, wherein a silver content of at least 50 ppm Ag and not more than 3000 ppm Ag is provided.

The copper layers 3 and 4 can be bonded to the ceramic carrier 2, for example, according to the DCB method described at the outset or with the AMB method, so that they are bonded to the ceramic carrier 2 by an integral joint in the respective surface edge zones 5 and 6.

The copper layers 3 and 4 with the proposed Cu and Ag contents, in particular with the proposed O contents of not more than 10 ppm, more preferably not more than 5 ppm, are highly conductive Cu materials and have a conductivity of 55 MS/m, preferably at least 57 MS/m and particularly preferably at least 58 MS/m.

The addition of Ag, the limitation of the phosphorus content to a maximum of 30 ppm and the presence of further elements in the copper layers 3, 4 makes it possible for the comparatively small Ag contents to be sufficient to counteract coarsening of the structure of the copper layers 3, 4 due to the thermal effect in the AMB method or DCB method, so that the copper layers 3, 4 of the copper-ceramic substrate 1 have a fine and homogeneous structure. This is particularly suitable, for example, for the etching of very fine structures. Furthermore, the fine structure results in an increased strength of the copper layers 3, 4 and thus an increased resistance to mechanical damage in accordance with the Hall-Petch relationship.

The semi-finished copper products of the copper layers 3 and 4 can have a thickness of 0.1 to 1.0 mm and are placed in large dimensions on the ceramic carrier 2 and bonded to the ceramic carrier 2 by the DCB method. The large-area copper-ceramic substrate 1 is then cut into smaller units and processed further. Alternatively, the bonding can be performed by the AMB method.

Such semi-finished copper products for the copper layers 3, 4 can be produced, for example, in production methods that exclude oxygen.

In addition, the copper layers 3 and 4 can have a content of the elements Cd, Ce, Ge, V, Zn in each case from a minimum of 0.01 to a maximum of 1 ppm and/or a content of the elements Bi, Se, Sn, Te in each case from a minimum of 0.01 to a maximum of 2 ppm, and/or a content of the elements Al, Sb, Ti, Zr in each case from a minimum of 0.01 to a maximum of 3 ppm and/or a content of the elements As, Co, In, Mn, Pb, Si in each case from a minimum of 0.01 to a maximum of 5 ppm, and/or a content of the elements B, Be, Cr, Fe, Mn, Ni, S in each case from a minimum of 0.01 to a maximum of 10 ppm. The enumerated additional elements can be deliberately introduced into the microstructure by doping during the melting process immediately before casting, or they can already be present in the copper layers 3 and 4 during the production of the semi-finished copper products. In any case, the content of these elements, including additional impurities, should preferably be not more than 50 ppm.

Furthermore, the copper layers 3, 4 according to a further preferred embodiment can have a content of the elements Cd, Ce, Ge, V, Zn of, altogether, at least 0.05 ppm and not more than 5 ppm, a content of the elements Bi, Se, Sn, Te of, altogether, at least 0.1 ppm and not more than 8 ppm, a content of the elements Al, Sb, Ti, Zr of, altogether, at least 0.1 ppm and not more than 10 ppm, a content of the elements As, Co, In, Mn, Pb, Si of, altogether, at least 0.1 ppm and not more than 20 ppm, and a content of the elements B, Be, Cr, Fe, Mn, Ni, S of, altogether, at least 0.1 ppm and not more than 50 ppm.

The described quantitative contents of the elements can help to produce the proposed mean grain size of the microstructure. The microstructure formation is caused in particular due to the particle refinement of the microstructure caused by the elements and to the reduction in secondary recrystallization in the microstructure during the bonding process.

FIG. 3 shows a micrograph of one of the copper layers 3, 4 of the copper-ceramic substrate 1, which was produced in a DCB method. In this exemplary embodiment, the structure of the copper layers 3, 4 is characterized by a mean grain size of 56.5 μm with a standard deviation of 28.5 μm and is thus below the requirements of 100 μm mean grain size. Grain sizes were determined according to the linear intercept method (DIN EN ISO 2624).

FIG. 4 shows a micrograph of one of the copper layers 3, 4 of the copper-ceramic substrate 1, which was produced in an AMB method. The structure of the copper layers 3, 4 is characterized in this exemplary embodiment by a mean grain size of 78 μm with a standard deviation of 34.6 μm and thus lies below the requirements of 100 μm mean grain size. Grain sizes were determined according to the linear intercept method (DIN EN ISO 2624).

The grain size distribution of the two exemplary embodiments according to FIGS. 3 and 4 is shown in FIG. 5. Both in the case of production according to the DCB method and according to the AMB method, a monomodal grain size distribution is produced in the copper layer(s) 3, 4.

In FIG. 6, penetration hardnesses in GPa are plotted over a normal displacement in μm of a nanohardness measurement by means of a depth-resolved QCSM method for a copper layer 3, 4 of one according to the DCB method (black circles), according to the AMB method (white circles) and a reference copper layer (black squares). The nanohardness measurement were performed with a plurality of stress levels, the maximum test force being 100 mN. A Berkovich indenter was used as the indenter. The penetration hardness is accordingly plotted as a function of the penetration depth. The surfaces of the copper layers 3, 4 of the copper-ceramic substrates 1 according to the invention exhibit a higher penetration hardness over all penetration depths of up to 3.5 μm over both production paths than the reference copper. It has been shown that with the proposed alloy a significantly improved penetration hardness for low penetration depths or near-surface region of the copper layers 3, 4 can be achieved. Among other things, this increases resistance to scratches and is advantageous for the resistance to mechanical effects in further processing operations. These properties of the high penetration hardness for the near-surface region of less than, for example, 2 μm, further for example 1 μm or even 0.5 μm, for example, is also advantageous for the application of very fine bonding wires in the ultrasonic welding method.

Furthermore, the structure of the copper layers 3, 4 of the copper-ceramic substrate 1 according to the invention produced according to the DCB method as well as according to the AMB method is characterized by increased twin formation. Twins can be detected in the micrograph as strips which correspond to the central region of a grain folded into the twin position. The microstructure can differ slightly in accordance with the selected production path, for example DCB (FIG. 7a) or AMB (FIG. 7b), of the copper-ceramic substrate 1.

Twin formation is indeed a known phenomenon in copper materials. In the case of the copper-ceramic substrate 1, enhanced twin formation is observed in the thermally activated joining process. Thus, thermal twin formation takes place in the recrystallization process. This is thermally induced twin formation (annealing twins). The twin formation has a positive influence on the hardness of the material, in particular in the case of fine structure.

The twins are colored dark in FIG. 7. According to FIG. 7a, for the structure of the copper layer 3, 4 according to the DCB method, an area proportion of the twins of 19.4% is obtained. For the copper layer 3, 4 according to the AMB method corresponding to the exemplary embodiment of FIG. 7b, a surface portion of the twin of 21.6% is obtained. Although the area portions mentioned differ only slightly from a reference copper, there are more smaller twins, which has a greater effect on the increase in hardness than large twins in smaller numbers.

1-10. (canceled)

11. A copper-ceramic substrate, comprising:
a ceramic carrier; and
at least one copper layer bonded to a corresponding at least one surface of the ceramic carrier,
wherein the at least one copper layer has a Cu content of at least 99.5%,
wherein the at least one copper layer has an Ag content of at least 50 ppm,
wherein the Ag content of the at least one copper layer is not more than 3000 ppm,
wherein the at least one copper layer has a P content of not more than 30 ppm, and
wherein the P content of the at least one copper layer is at least 0.1 ppm.

12. The copper-ceramic substrate according to claim 11,
wherein the at least one copper layer has a mean grain size between 40 μm and 100 μm.

13. The copper-ceramic substrate according to claim 12,
wherein the mean grain size of the at least one copper layer is between 40 μm and 80 μm.

14. The copper-ceramic substrate according to claim 11,
wherein the at least one copper layer has a penetration hardness of at least 0.7 GPa for penetration depths between 0.4 μm and 0.6 μm.

15. The copper-ceramic substrate according to claim 11,
wherein the at least one copper layer has a penetration hardness of at least 0.8 GPa for penetration depths between 0.1 μm and 0.25 μm.

16. The copper-ceramic substrate according to claim 11,
wherein the at least one copper layer has an O content of not more than 10 ppm.

17. The copper-ceramic substrate according to claim 11,
wherein the at least one copper layer has an O content of at least 0.1 ppm.

18. The copper-ceramic substrate according to claim 11,
wherein the at least one copper layer has a content of elements Cd, Ce, Ge, V, Zn, Bi, Se, Sn, Te, Al, Sb, Ti, Zr, As, Co, In, Mn, Pb, Si, B, Be, Cr, Fe, Mn, Ni and S, including further impurities, of not more than 50 ppm.
